(19) United States
(12) Patent Application Publication
(10) Pub. No.: US 2026/0073596 A1
(43) Pub. Date: Mar. 12, 2026

(54) AUTO-GENERATED PROMPT SYSTEM AND METHOD FOR GUIDING IMAGE CAPTURE

(71) Applicant: Perfect Mobile Corp., New Taipei City (TW)

(72) Inventors: Chia-Che YANG, New Taipei City (TW); Chiao-Yu YANG, Kaohsiung City (TW)

(21) Appl. No.: 19/363,268

(22) Filed: Oct. 20, 2025

Related U.S. Application Data
(63) Continuation-in-part of application No. 19/321,773, filed on Sep. 8, 2025.
(60) Provisional application No. 63/692,777, filed on Sep. 10, 2024.
(60) Provisional application No. 63/870,516, filed on Aug. 26, 2025.

(51) Int. Cl. G06T 11/60; G06V 10/70; G06V 10/77

(52) U.S. Cl. CPC G06T 11/60; G06V 10/768; G06V 10/7715; G06V 2201/07

(57) ABSTRACT

A computing device obtains an image and detects at least one target object depicted in the image. The computing device applies a visual-language model (VLM) to extract the contextual cues from the image relating to the at least one target object. The computing device obtains an aesthetic rule describing a desired post-processing result and generates editing prompts based on the contextual cues and the aesthetic rule. The computing device performs post-processing on the image by the generative artificial intelligence model based on the editing prompts and outputs a modified image.

### CROSS-REFERENCE TO RELATED APPLICATION

This application is a continuation-in-part application of and claims priority to, and the benefit of, U.S. Ser. No. 19/321,773 entitled “Auto-Generated Prompt System and Method for Guiding Image Capture” filed on Sep. 8, 2025, which claims priority to, and the benefit of, U.S. Provisional Patent Application entitled, “AI Photo Tutor,” having Ser. No. 63/692,777, filed on Sep. 10, 2024, and U.S. Provisional Patent Application entitled, “AI Photo Editing Tutor,” having Ser. No. 63/870,516, filed on Aug. 26, 2025, which are all incorporated by reference in their entireties.

### TECHNICAL FIELD

The present disclosure generally relates to systems and methods for providing auto-generated prompts to guide image capture.

### SUMMARY

In accordance with one embodiment, a computing device obtains an image and detects at least one target object depicted in the image. The computing device applies a visual-language model (VLM) to extract the contextual cues from the image relating to the at least one target object. The computing device obtains an aesthetic rule describing a desired post-processing result and generates editing prompts based on the contextual cues and the aesthetic rule. The computing device performs post-processing on the image by the generative artificial intelligence model based on the editing prompts and outputs a modified image.

Another embodiment is a system that comprises a memory storing instructions and a processor coupled to the memory. The processor is configured to obtain an image and detect at least one target object depicted in the image. The processor is further configured to apply a visual-language model (VLM) to extract the contextual cues from the image relating to the at least one target object. The processor is further configured to obtain an aesthetic rule describing a desired post-processing result and generate editing prompts based on the contextual cues and the aesthetic rule. The processor is further configured to perform post-processing on the image by the generative artificial intelligence model based on the editing prompts and output a modified image.

Another embodiment is a non-transitory computer-readable storage medium storing instructions to be executed by a computing device. The computing device comprises a processor, wherein the instructions, when executed by the processor, cause the computing device to obtain an image and detect at least one target object depicted in the image. The processor is further configured by the instructions to apply a visual-language model (VLM) to extract the contextual cues from the image relating to the at least one target object. The processor is further configured by the instructions to obtain an aesthetic rule describing a desired post-processing result and generate editing prompts based on the contextual cues and the aesthetic rule. The processor is further configured by the instructions to perform post-processing on the image by the generative artificial intelligence model based on the editing prompts and output a modified image.

Other systems, methods, features, and advantages of the present disclosure will be apparent to one skilled in the art upon examining the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Various aspects of the disclosure are better understood with reference to the following drawings. The components in the drawings are not necessarily to scale, with emphasis instead being placed upon clearly illustrating the principles of the present disclosure. Moreover, in the drawings, like reference numerals designate corresponding parts throughout the several views.

FIG. 1 is a block diagram of a computing device configured to provide auto-generated prompts for guiding image capture according to various embodiments of the present disclosure.

FIG. 2 is a schematic diagram of the computing device of FIG. 1 in accordance with various embodiments of the present disclosure.

FIG. 3 is a top-level flowchart illustrating examples of functionality implemented as portions of the computing device of FIG. 1 for providing auto-generated prompts for guiding image capture according to various embodiments of the present disclosure.

FIG. 4 illustrates an image capture session performed by the computing device of FIG. 1 according to various embodiments of the present disclosure.

FIG. 5 illustrates the contextual cue extractor of FIG. 1 identifying target objects within the field of view of the image capture device according to various embodiments of the present disclosure.

FIG. 6 provides examples of contextual cues associated with the target objects according to various embodiments of the present disclosure.

FIG. 7 illustrates the computing device of FIG. 1 obtaining a description of a desired resulting image from the user according to various embodiments of the present disclosure.

FIG. 8 illustrates an example of real-time prompts generated by the guidance module of FIG. 1 based on the contextual cues and the user input according to various embodiments of the present disclosure.

FIG. 9 illustrates the guidance module of FIG. 1 generating a final prompt instructing the user to capture an image of the target objects using the image capture device according to various embodiments of the present disclosure.

FIG. 10 is a top-level flowchart illustrating examples of functionality implemented as portions of the computing device of FIG. 1 for providing an artificial intelligence photo editing tutor according to various embodiments of the present disclosure.

### DETAILED DESCRIPTION

The subject disclosure is now described with reference to the drawings, where like reference numerals are used to refer to like elements throughout the following description. Other aspects, advantages, and novel features of the disclosed subject matter will become apparent from the following detailed description and corresponding drawings.

Although image capture devices are ubiquitous and the capabilities of image capture devices are constantly improving, it can be challenging for individuals who lack in depth knowledge of photography skills to capture high quality images similar to those captured by professional photographers. Selecting the optimal settings for such parameters as the shutter speed, aperture, ISO, etc. can be difficult for individuals who lack the expertise.

Embodiments are disclosed for an intelligent image capture guidance system and method for assisting users in capturing high quality photographs by providing real-time guidance and feedback. Implementation of various embodiments achieve significant improvement in the technical field of digital photography by introducing real-time user feedback based on analysis of contextual cues extracted from a field of view of the image capture device, thereby addressing challenges related to the lack of technical knowledge for capturing high-end images. Embodiments leverage the use of artificial intelligence (AI) to enhance the resulting images captured by the image capture device.

Other embodiments are disclosed for implementing an artificial intelligence (AI) photo editing tutor. For such embodiments, an image selected by a user for post-processing is received. Using vision-language models (VLMs), key subjects or objects within the image are detected, and contextual cues including layout, composition, scene balance, and so on are extracted from the image. Based on either user-defined intent or automated analysis, prompts are generated to guide a generative AI model to produce a new version of the image with modified composition (e.g., subject repositioning, angle changes, layout adjustment). The edited image may undergo further refinement through iterative feedback from the user or by applying one-click enhancement for autonomous composition improvement.

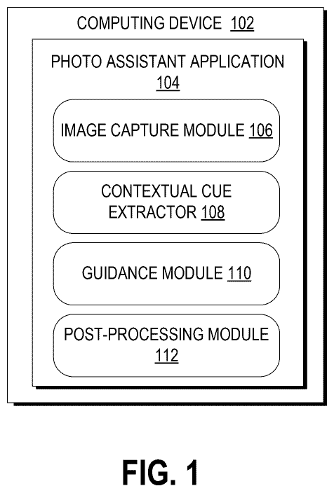

A system for providing auto-generated prompts for guiding image capture based on contextual cues is described followed by a discussion of the operation of the components within the system. FIG. 1 is a block diagram of a computing device 102 in which the embodiments disclosed herein may be implemented. The computing device 102 may comprise one or more processors that execute machine executable instructions to perform the features described herein. For example, the computing device 102 may be embodied as a computing device such as, but not limited to, a smartphone, a tablet-computing device, a laptop, and so on.

A photo assistant application 104 executes on a processor of the computing device 102 and includes an image capture module 106, a contextual cue extractor 108, a guidance module 110, and a post-processing module 112. The image capture module 106 is executed on a processor of the computing device 102 to detect initiation of an image capture session for capturing images or videos, where the image capture session is carried out through operation of a rear-facing camera or other image capture device of the computing device 102 or image capture device communicatively coupled to the computing device 102. In some implementations, the computing device 102 may be equipped with the capability to connect to the Internet, and the image capture module 106 may be configured to operate a remote device equipped with a camera to obtain images or videos.

The images captured or obtained by the image capture module 106 may be encoded in any of a number of formats including, but not limited to, JPEG (Joint Photographic Experts Group) files, TIFF (Tagged Image File Format) files, PNG (Portable Network Graphics) files, GIF (Graphics Interchange Format) files, BMP (bitmap) files or any number of other digital formats. The videos may be encoded in formats including, but not limited to, Motion Picture Experts Group (MPEG)-1, MPEG-2, MPEG-4, H.264, Third Generation Partnership Project (3GPP), 3GPP-2, Standard-Definition Video (SD-Video), High-Definition Video (HD-Video), Digital Versatile Disc (DVD) multimedia, Video Compact Disc (VCD) multimedia, High-Definition Digital Versatile Disc (HD-DVD) multimedia, Digital Television Video/High-definition Digital Television (DTV/HDTV) multimedia, Audio Video Interleave (AVI), Digital Video (DV), QuickTime (QT) file, Windows Media Video (WMV), Advanced System Format (ASF), Real Media (RM), Flash Media (FLV), an MPEG Audio Layer III (MP3), an MPEG Audio Layer II (MP2), Waveform Audio Format (WAV), Windows Media Audio (WMA), 360 degree video, 3D scan model, or any number of other digital formats.

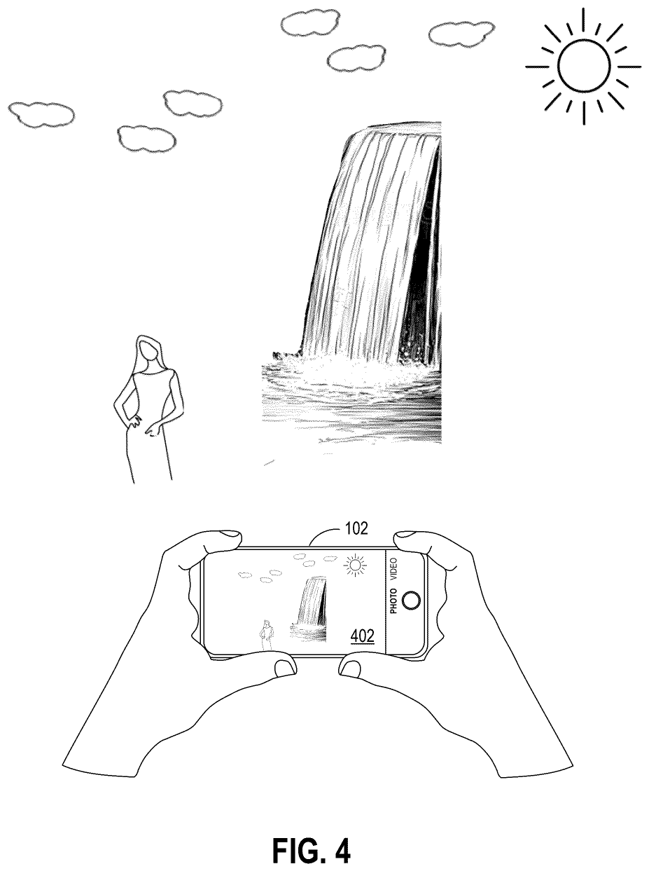

To further illustrate functionality of the image capture module 106, reference is made to FIG. 4, which shows an image capture session performed by the computing device 102. For some embodiments, the user utilizes a user interface 402 displaying the field of view of the image capture device to conduct the image capture session where the field of view corresponds to the viewable area captured by the lens system of the image capture device. The image capture module 106 detects when the user initiates an image capture session and communicates detection of this event to the contextual cue extractor 108 (FIG. 1). This may comprise, for example, detecting when the user selects a camera application on the home screen displayed on the computing device 102 and when the user selects a camera mode once the camera application executes.

Referring back to FIG. 1, the contextual cue extractor 108 is executed by the processor of the computing device 102 to detect one or more target objects present in the field of view of the image capture device. Upon detecting that an image capture session has been initiated by the user, the image capture module 106 communicates with the contextual cue extractor 108, which then identifies one or more target objects depicted in the field of view.

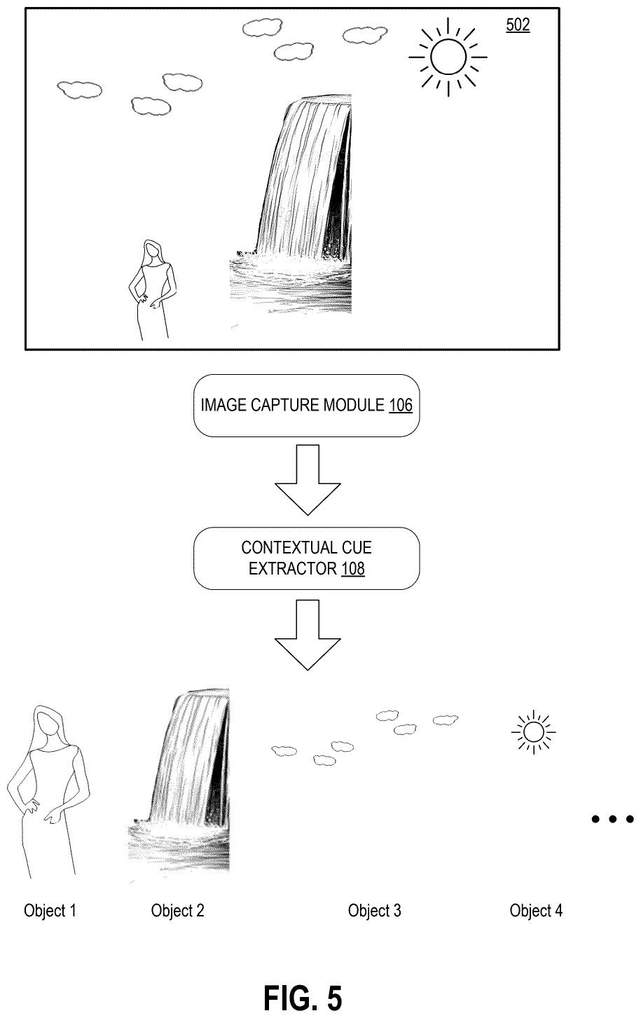

To illustrate, reference is made to FIG. 5. In the example shown, the target objects detected in the field of view 502 of the image capture device comprise an individual and scenery objects such as a waterfall, clouds, the sun, and so on. The contextual cue extractor 108 then derives contextual cues relating to the detected target objects, where the contextual cues provide, for example, information relating to visual elements in the field of view of the image capture device and provide context of the scenery being shown on the computing device 102. The contextual cues may also provide context relating to the time of day, event, mood of individuals shown in the field of view, and so on.

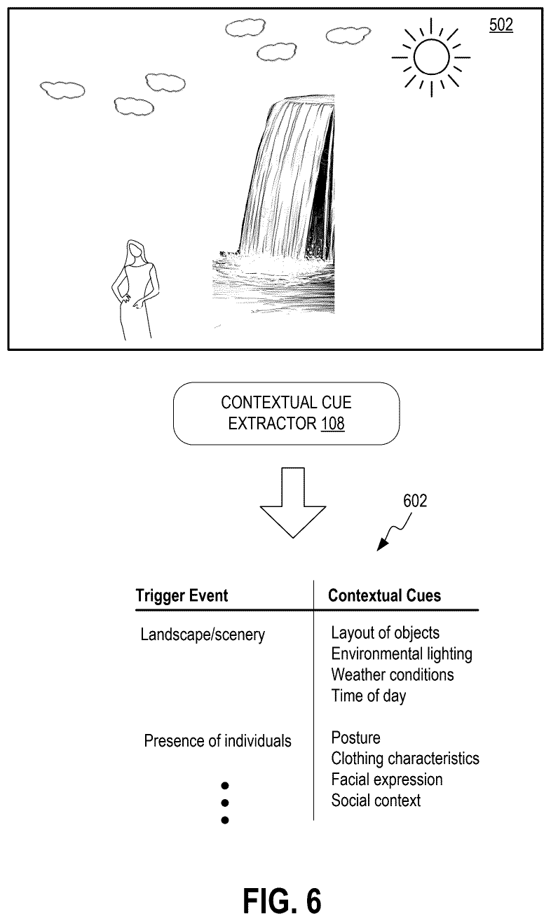

Continuing to FIG. 6, the contextual cue extractor 108 derives contextual cues 602 from the field of view 502 of the image capture device based on the detection of trigger events. In some embodiments, trigger events may comprise, for example, the presence of landscape/scenery including trees, mountains, lakes, and so on. Other trigger events may comprise the presence of individuals in the field of view. The contextual cue extractor 108 derives contextual cues associated with each trigger event.

As shown earlier in FIG. 5, the contextual cue extractor 108 detects the presence of scenery objects comprising, for example, a waterfall, clouds, the sun, and so on. Based on this, the contextual cue extractor 108 derives information relating to the relative layout of the objects, the environmental lighting, weather conditions, the time of day, and so on. As further shown in FIG. 6, the contextual cue extractor 108 also detects the presence of an individual in the field of view. Based on this, the contextual cue extractor 108 derives information relating to the posture of the individual, clothing worn by the individual, the individual's facial expression, whether the individual is interacting with other individuals, and so on.

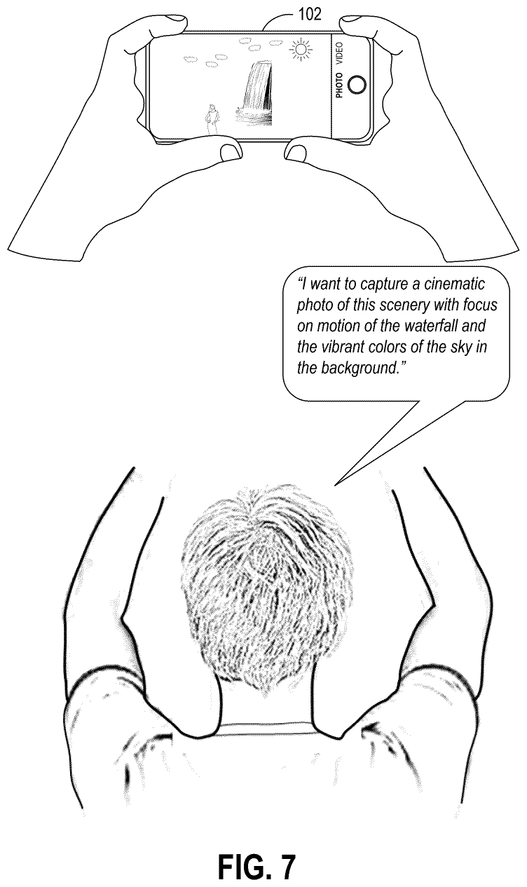

Referring back to the system diagram of FIG. 1, the photo assistant application 104 includes a guidance module 110 configured to obtain input from the user describing a desired resulting image depicting the one or more target objects shown in the field of view of the image capture device. The user may specify the desired resulting image capturing through the use of an input device such as a touchscreen interface or by describing the desired resulting image to the computing device 102, which receives the input in this case through a built-in microphone. In the example shown in FIG. 7, the user verbally describes a desired result to the computing device 102.

To achieve the desired result specified by the user, the guidance module 110 utilizes an artificial intelligence (AI) model trained by a collection of samples images comprising, for example, images captured by professional photographers, highly-rated images on social media, and so on. During a training phase, the guidance module 110 processes the collection of sample images and analyzes image capture device operation settings and corresponding contextual cues associated with each sample image. In some embodiments, the guidance module 110 identifies prominent features depicted in each sample image by applying photo composition techniques, lighting analysis, edge detection, semantic segmentation, detection models, digital signal processing, and other techniques.

The guidance module 110 utilizes the extracted information to train the AI model, which may group the collection of sample images into different clusters based on similarity of prominent features, image capture device settings, and so on. The guidance module 110 identifies a closest matching cluster of sample images based on the content depicted in the field of view of the image capture device and based on the desired resulting image verbally described by the user.

As the image capture device operation settings may vary significantly across the sample images in a closest matching cluster, the guidance module 110 may sort or prioritize image capture device operation settings according to the degree of difficulty or complexity for the user to set. For some embodiments, the image capture device operation settings with the highest priority may be presented to the user to serve as guidance on how to achieve the desired look specified by the user.

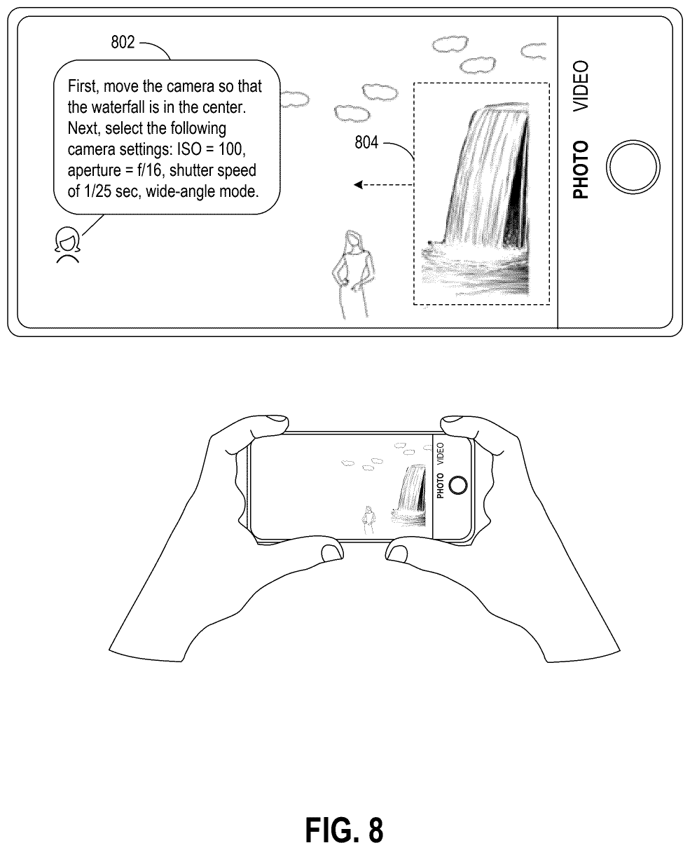

FIG. 8 illustrates an example of real-time prompts generated by the guidance module 110 based on the contextual cues and the input provided earlier by the user relating to a desired resulting image. For some embodiments, the real-time prompts guide the user to achieve at least one target condition, where the guidance module 110 monitors the user's behavior to determine whether any target conditions are met. The target conditions may comprise the user adjusting specific operation settings of the image capture device, as directed by the guidance module 110 using the real-time prompts.

In the example shown, one of the real-time prompts displayed to the user comprises textual instructions 802 guiding the user on how to position the image capture device. The textual instructions 802 also guide the user to set specific operation settings for the image capture device. Note that the real-time prompts may also comprise graphical cues provided to the user such as grid lines or other graphical elements displayed in the user interface that highlight one or more target objects. In the example shown in FIG. 8, one of the real-time prompts comprises a box and arrow 804 around the water fall object that guides the user on how to reposition the image capture device so that the water fall is centered in the field of view.

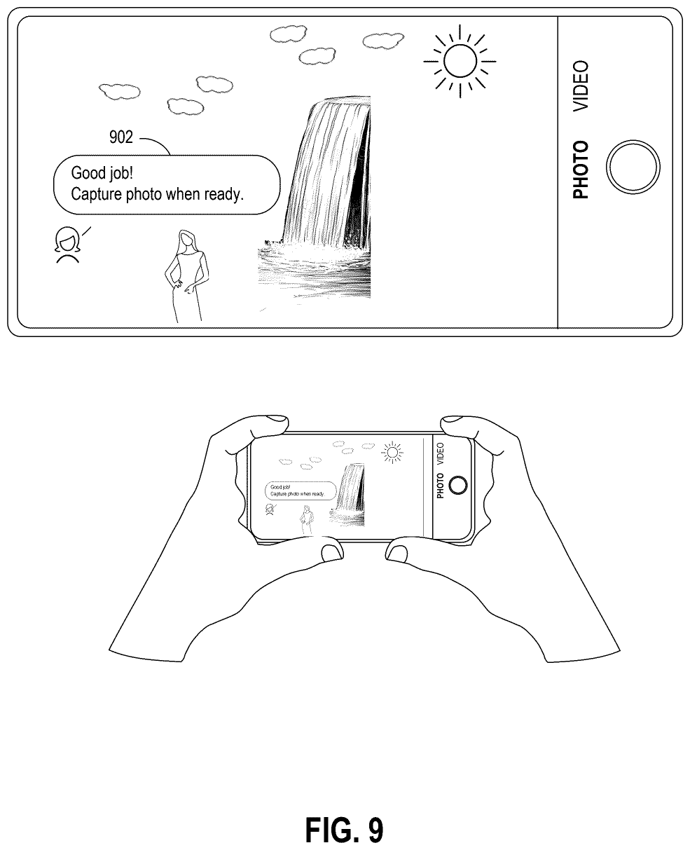

FIG. 9 illustrates additional functionality of the guidance module 110. For some embodiments, the guidance module 110 detects when at least one target condition is met and generates a final prompt instructing the user to capture an image of the target objects using the image capture device if a threshold number of target conditions are met. For example, if suggested positioning of target objects in the field of view of the image capture device is not met but all the operating settings of the image capture device are satisfactorily adjusted, the guidance module 110 may alert the user that an image is ready to be captured. In other instances, however, additional real-time prompts may be generated by the guidance module 110 to achieve the threshold number of target conditions. Responsive to the final prompt, the user captures a resulting image as directed by the guidance module 110.

In some instances, the resulting image captured by the user may not meet the user's desired expectations. Referring back to the system diagram in FIG. 1, the photo assistant application 104 may further comprise a post-processing module 112 configured to perform touch-ups and other modifications to more closely align with the criteria specified by the user. For some embodiments, the post-processing module 112 communicates with the AI model of the guidance module 110 to assist in automatically editing the captured image to generate a modified resulting image.

For some embodiments, the post-processing module 112 is configured to perform post-processing on the captured image utilizing a generative AI model based on the contextual cues extracted by the contextual cue extractor 108. For some embodiments, the contextual cue extractor 108 applies a visual-language model (VLM) to extract the contextual cues from the captured image and obtains an aesthetic rule describing a desired post-processing result. The post-processing module 112 generates editing prompts based on the contextual cues and the aesthetic rule and inputs the editing prompts into the generative AI model to output a modified captured image. The post-processing module 112 may perform the operations described above over multiple iterations, depending on whether the user wishes to further refine the captured image. The aesthetic rule describing the desired post-processing result may comprise user input in the form of textual description or other form of user input. The aesthetic rule may also comprise a pre-defined rule that specifies the desired post-processing result.

For some embodiments, the post-processing module 112 executing in the computing device 102 is configured to receive an input image provided by a user for post-processing. The post-processing module 112 utilizes VLM to detect key subjects or objects within the input image and extracts contextual cues comprising, for example, layout information, composition, scene balance, and so on. Other examples of contextual cues include subject positioning, framing balance, perspective, background complexity, leading lines, and so on.

Leveraging the use of VLM helps to ensure accurate semantic interpretation of image content as well as accurate interpretation of input (e.g., textual description) provided by the user. Specifically, the computing device 102 utilizes VLM to analyze the input image to identify objects/subjects, scenery information, relationship between the objects/subjects, and so on. The computing device 102 further utilizes VLM to accurately interpret user input and to apply the user input to relevant regions in the input image during the editing process. The computing device 102 also utilizes VLM to extract rich contextual cues that guide prompt generation logic executing in the computing device 102. For example, utilizing VLM allows the computing device 102 to identify the main subject in the input image, determine whether the main subject is too far from the center of the input image, determine whether there is visual balance in the input image, and so on.

The post-processing module 112 generates one or more prompts that are input to a generative AI model executing in the computing device 102 to perform such modifications as repositioning one or more subjects in the input image, changing the image-capture angle, adjusting the overall layout of the input image, and so on. The prompts may be embodied as text prompts, structured prompts, and so on. These prompts are input into the generative AI model to produce an edited version of the input image. For some embodiments, the prompts comprise instructions for performing multi-stage editing and are directed to generating segmentation masks for isolating the main subject or background, generating outline or depth maps to guide the post-processing module 112 in performing spatial rearrangement, generating bounding boxes for modifying the overall layout of the input image, and so on. The generative AI model utilized by the computing device 102 may comprise, for example, a diffusion-based model or a transformer-based model.

The post-processing module 112 generates the one or more prompts based on user-defined criteria and/or automated analysis and enhancement performed by the computing device 102. The user-defined criteria obtained by the computing device 102 may comprise a textual description (e.g., “center the subject,” “apply rule of thirds,” “zoom out”). The post-processing module 112 may further refine the modified input image through iterative feedback from the user or by applying one-click enhancement for autonomous composition improvement by the post-processing module 112.

The automated analysis and enhancement performed by the post-processing module 112 may be performed based on predefined aesthetic models or rules. Specifically, the automated analysis and enhancement may be performed by comparing the modified input image to composition quality metrics that quantify target balance levels, symmetry, object saliency, and so on. If such quality metrics are not met, the computing device 102 may perform automated enhancement to further refine the modified input image until such quality metrics are met. The post-processing module 112 may perform such editing operations as repositioning one or more subjects in the input image, adjusting the background overall layout of the input image, performing perspective transform operations on the input image, and so on. If the target object is occluded or the feature score is too low, the computing device 102 may prompt the user, for example, to “change position” or “adjust focal length” and provides alternative compositions (e.g., switch to a diagonal composition). If the generative model produces obvious distortions (as detected by facial naturalness scoring or structural consistency checks), the computing device 102 automatically falls back to non-generative correction or requests the user to adopt more conservative rules.

For some embodiments, the automated analysis and enhancement performed by the post-processing module 112 may utilize training data and fine-tuning techniques. Specifically, the post-processing module 112 may utilize multi-source datasets including, for example, professional photography databases, annotated high-engagement social media images, and synthetic data (with layout/lighting perturbations). In some embodiments, weakly supervised aesthetic scores (crowd rating) are combined with contrastive learning, and domain adaptation is employed to align the models with the camera lens and ISP characteristics of the image capture device of the computing device 102.

For some embodiments, the post-processing module 112 provides automatic rule generation where no user input is required. For such embodiments, the post-processing module 112 may automatically generate a rule based on context. For example, when detecting an “outdoor backlit portrait,” the post-processing module 112 may apply a backlight portrait template directed to background softening, subject highlight recovery, skin tone preservation, hair-edge sharpening, and so on. When detecting a “product for e-commerce,” for example, the post-processing module 112 may apply a catalog_clean_bg template directed to a white background, centered symmetry, shadow softening, and so on.

In some implementations, the computing device 102 may be embodied as a wearable device with hands-free control. For example, the computing device 102 may be embodied in augmented reality (AR) glasses of a head-mounted device, where prompts are displayed as heads-up display (HUD) overlays and where voice/eye-tracking features serve as primary interaction modalities. The computing device 102 can detect hand tremors and gait, proactively suggesting stabilization, short burst captures, or automatic shutter delay to improve success rates.

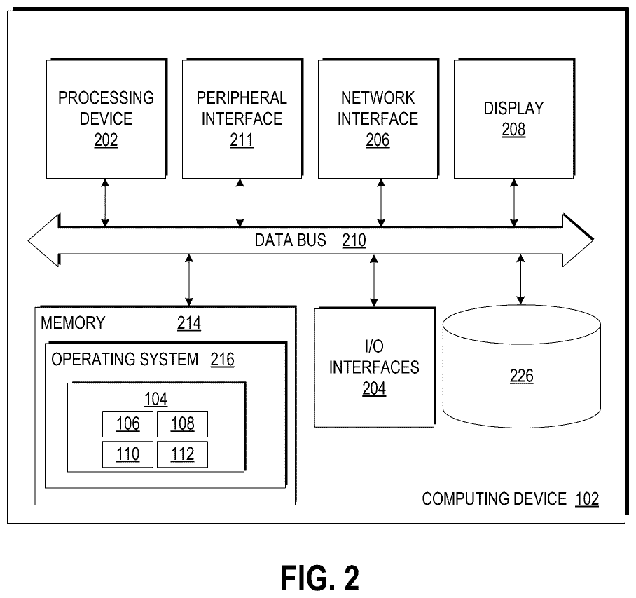

FIG. 2 illustrates a schematic block diagram of the computing device 102 in FIG. 1. The computing device 102 may be embodied as a desktop computer, portable computer, dedicated server computer, multiprocessor computing device, smart phone, tablet, and so forth. As shown in FIG. 2, the computing device 102 comprises memory 214, a processing device 202, a number of input/output interfaces 204, a network interface 206, a display 208, a peripheral interface 211, and mass storage 226, wherein each of these components are connected across a local data bus 210.

The processing device 202 may include a custom made processor, a central processing unit (CPU), or an auxiliary processor among several processors associated with the computing device 102, a semiconductor based microprocessor (in the form of a microchip), a macroprocessor, one or more application specific integrated circuits (ASICs), a plurality of suitably configured digital logic gates, and so forth.

The memory 214 may include one or a combination of volatile memory elements (e.g., random-access memory (RAM) such as DRAM and SRAM) and nonvolatile memory elements (e.g., ROM, hard drive, tape, CDROM). The memory 214 typically comprises a native operating system 216, one or more native applications, emulation systems, or emulated applications for any of a variety of operating systems and/or emulated hardware platforms, emulated operating systems, etc. For example, the applications may include application specific software that may comprise some or all the components of the computing device 102 displayed in FIG. 1.

In accordance with such embodiments, the components are stored in memory 214 and executed by the processing device 202, thereby causing the processing device 202 to perform the operations/functions disclosed herein. For some embodiments, the components in the computing device 102 may be implemented by hardware and/or software.

Input/output interfaces 204 provide interfaces for the input and output of data. For example, where the computing device 102 comprises a personal computer, these components may interface with one or more input/output interfaces 204, which may comprise a keyboard or a mouse, as shown in FIG. 2. The display 208 may comprise a computer monitor, a plasma screen for a PC, a liquid crystal display (LCD) on a hand held device, a touchscreen, or other display device.

In the context of this disclosure, a non-transitory computer-readable medium stores programs for use by or in connection with an instruction execution system, apparatus, or device. More specific examples of a computer-readable medium may include by way of example and without limitation: a portable computer diskette, a random access memory (RAM), a read-only memory (ROM), an erasable programmable read-only memory (EPROM, EEPROM, or Flash memory), and a portable compact disc read-only memory (CDROM) (optical).

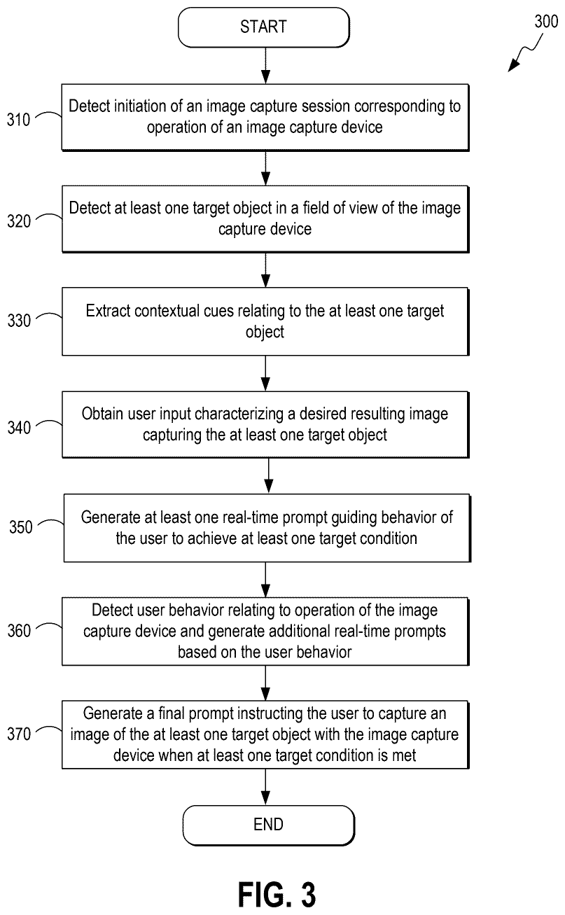

Reference is made to FIG. 3, which is a flowchart 300 in accordance with various embodiments for providing auto-generated prompts for guiding photo capture, where the operations are performed by the computing device 102 of FIG. 1. It is understood that the flowchart 300 of FIG. 3 provides merely an example of the different types of functional arrangements that may be employed to implement the operation of the various components of the computing device 102. As an alternative, the flowchart 300 of FIG. 3 may be viewed as depicting an example of steps of a method implemented in the computing device 102 according to one or more embodiments.

Although the flowchart 300 of FIG. 3 shows a specific order of execution, it is understood that the order of execution may differ from that which is displayed. For example, the order of execution of two or more blocks may be scrambled relative to the order shown. In addition, two or more blocks shown in succession in FIG. 3 may be executed concurrently or with partial concurrence. It is understood that all such variations are within the scope of the present disclosure.

At block 310, the computing device 102 detects initiation of an image capture session corresponding to operation of an image capture device. At block 320, the computing device 102 detects one or more target objects in a field of view of the image capture device. The target objects detected in the field of view of the image capture device comprise individuals, scenery objects, man-made structures, and so on.

At block 330, the computing device 102 extracts contextual cues relating to the one or more target objects identified in block 320. For some embodiments, the computing device 102 extracts the contextual cues by first classifying each target object into a pre-defined object category (e.g., man-made structure). The contextual cues provide information relating to visual elements in the field of view of the image capture device and provide context of the scenery being shown on the computing device 102. For example, the contextual cues may provide context relating to the time of day, event, and mood of individuals shown in the field of view. The contextual cues may also provide information relating to the positioning and people, objects, and so on. The contextual cues may also provide information relating to the relative size and proportions between people and objects within the image. As another example, the contextual cues may correspond to environmental conditions surrounding the one or more target objects, where the environmental conditions comprise background objects and/or environmental lighting.

At block 340, the computing device 102 obtains user input characterizing a desired resulting image capturing the one or more target objects identified in block 320. The user may specify the desired resulting image capturing through the use of an input device such as a touchscreen interface or by describing the desired resulting image to the computing device 102, which receives the input in this case through a built-in microphone.

At block 350, the computing device 102 generates one or more real-time prompts based on the contextual cues and the user input, where the real-time prompts guide behavior of the user to achieve at least one target condition. The real-time prompts may comprise, for example, a prompt displayed in a user interface on the computing device, a graphical element highlighting the least one target object in the user interface on the computing device, an overlay chart displayed in the user interface on the computing device for adjusting a field of view of the image capture device and/or a voice prompt output by the computing device 102. The real-time prompts may comprise, for example, instructions on how to orient the camera, set the zoom level of the camera, enable camera flash, set such camera parameters as the exposure level, and so on. Such instructions may be conveyed to the user using, for example, silhouette maps and anchor points displayed to the user.

For some embodiments, the computing device 102 utilizes an AI model to generate the one or more real-time prompts. The AI model is trained by a collection of samples images comprising, for example, images captured by professional photographers, highly-rated images on social media and so on. The computing device 102 processes the collection of sample images and analyzes image capture device operation settings and corresponding contextual cues associated with each sample image. The one or more target conditions may comprise the user adjusting the image capture device according to suggested operation settings provided by the computing device.

At block 360, the computing device 102 detects user behavior relating to operation of the image capture device and generates additional real-time prompts based on the user behavior. For example, additional real-time prompts may be needed to further guide the user in some instances. At block 370, the computing device 102 generates a final prompt instructing the user to capture an image of the one or more target objects with the image capture device when at least one of the target condition is met.

For some embodiments, the computing device 102 performs post-processing on the captured image of the one or more target objects, where the post-processing is performed utilizing generative AI model based on contextual cues extracted from the captured image. For some embodiments, the post-processing performed by the computing device 102 comprises applying a visual-language model (VLM) to extract the contextual cues from the captured image and obtaining an aesthetic rule describing a desired post-processing result. The post-processing feature further comprises generating editing prompts based on the contextual cues and the aesthetic rule and inputting the editing prompts into the generative AI model and outputting a modified captured image. The aesthetic rule describing the desired post-processing result may comprise user input or a pre-defined rule. In some instances, the user may wish to further refine the modified captured image. In such instances, the computing device 102 obtains user input comprising a new aesthetic rule for refining the modified captured image and generates new editing prompts based on the contextual cues and the new aesthetic rule. The new editing prompts are input into the generative AI model and another modified captured image is output by the computing device 102.

In some embodiments, the AI model is further configured to dynamically update real-time prompts based on analysis of user behavior during the image capture session. For instance, if the computing device 102 detects that the user repeatedly tilts the image capture device in a manner inconsistent with the suggested orientation, the AI model may adjust subsequent prompts to provide alternative guidance more suitable to the user's behavior. Similarly, if hand tremors or device shaking are detected, the AI model may adapt the prompts to suggest enabling image stabilization features or leaning the device against a fixed surface.

In some embodiments, the post-processing module 112 may generate an aesthetic rule without direct user input by leveraging external data sources. For example, the post-processing module 112 may automatically extract stylistic trends from highly-rated social media images, recent photography competitions, or predefined aesthetic templates to create a contextually appropriate rule. The generated aesthetic rule may specify enhancements such as skin smoothing, brightness adjustments, or background blurring, which are then translated into editing prompts for the generative AI model.

In further embodiments, the computing device 102 is not limited to smartphones, tablets, or laptops, but may also include wearable devices such as augmented reality (AR) glasses, virtual reality (VR) headsets, or smart eyewear equipped with image capture functionality. When implemented in such wearable devices, the real-time prompts may be displayed directly in the user's field of view via a heads-up display, and voice prompts may be delivered through integrated audio systems. Such embodiments expand the scope of applications to hands-free photography, immersive video capture, and live-streaming scenarios. Thereafter, the process in FIG. 3 ends.

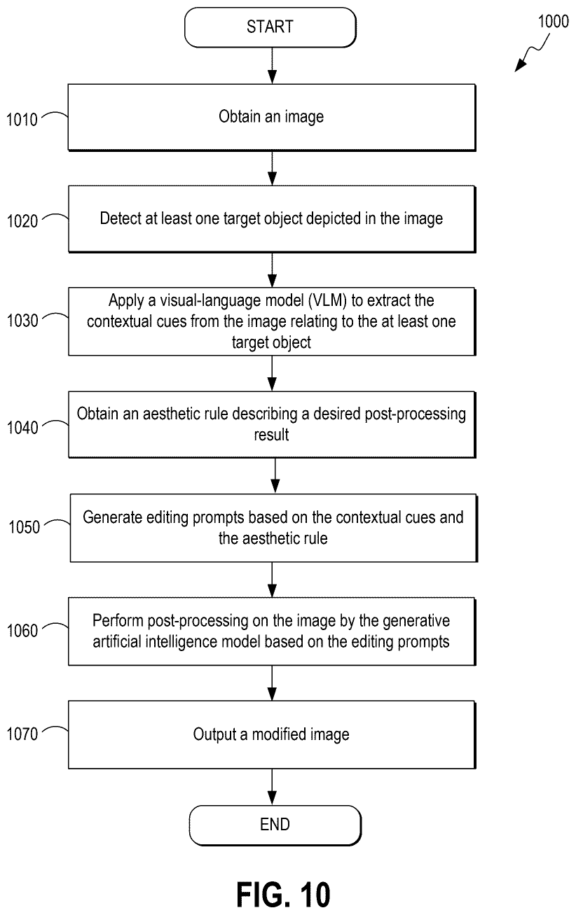

Reference is made to FIG. 10, which is a flowchart 1000 in accordance with various embodiments for providing an artificial intelligence photo editing tutor, where the operations are performed by the computing device 102 of FIG. 1. It is understood that the flowchart 1000 of FIG. 10 provides merely an example of the different types of functional arrangements that may be employed to implement the operation of the various components of the computing device 102. As an alternative, the flowchart 1000 of FIG. 10 may be viewed as depicting an example of steps of a method implemented in the computing device 102 according to one or more embodiments.

Although the flowchart 1000 of FIG. 10 shows a specific order of execution, it is understood that the order of execution may differ from that which is displayed. For example, the order of execution of two or more blocks may be scrambled relative to the order shown. In addition, two or more blocks shown in succession in FIG. 10 may be executed concurrently or with partial concurrence. It is understood that all such variations are within the scope of the present disclosure.

At block 1010, the computing device 102 obtains an image, and at block 1020, the computing device 102 detects one or more target objects depicted in the image. At block 1030, the computing device 102 applies a visual-language model (VLM) to extract the contextual cues from the image relating to the at least one target object. For some embodiments, the contextual cues include positioning of the at least one target object in the image, framing balance, perspective, background complexity, and/or leading lines.

At block 1040, the computing device 102 obtains an aesthetic rule describing a desired post-processing result. The aesthetic rule may comprise user-specified descriptive text or a pre-defined rule. At block 1050, the computing device 102 generates editing prompts based on the contextual cues and the aesthetic rule. For some embodiments, the computing device 102 generates the editing prompts for repositioning of the at least one target object within the image, modifying a background of the image, and/or transforming a perspective of the image for adjusting spatial relationship between the at least one target object and other objects depicted in the image.

At block 1060, the computing device 102 performs post-processing on the image using the generative artificial intelligence model based on the editing prompts, and at block 1070, the computing device 102 outputs a modified image. For some embodiments, the computing device 102 obtains user input comprising an additional aesthetic rule for refining the modified image and generates new editing prompts based on the contextual cues and the additional aesthetic rule. The computing device 102 then inputs the new editing prompts into the generative AI model and outputs a refined modified image. Thereafter, the process in FIG. 10 ends.

The embodiments described above in the present disclosure are possible examples of implementations set forth for an understanding of the principles of the disclosure. Variations and modifications may be made to the one or more embodiments described herein without departing substantially from the spirit and principles of the disclosure. All such modifications and variations are included herein within the scope of this disclosure and protected by the following claims.

At least the following is claimed:

1. A method implemented in a computing device, comprising:
obtaining an image;
detecting at least one target object depicted in the image;
applying a visual-language model (VLM) to extract the contextual cues from the image relating to the at least one target object;
obtaining an aesthetic rule describing a desired post-processing result;
generating editing prompts based on the contextual cues and the aesthetic rule;
performing post-processing on the image by the generative artificial intelligence model based on the editing prompts; and
outputting a modified image.

2. The method of claim 1, wherein the contextual cues comprise at least one of: positioning of the at least one target object in the image, framing balance, perspective, background complexity, or leading lines.

3. The method of claim 1, wherein the aesthetic rule describing the desired post-processing result comprises one of: user input comprising descriptive text or a pre-defined rule.

4. The method of claim 1, further comprising:
obtaining user input comprising an additional aesthetic rule for refining the modified image;
generating new editing prompts based on the contextual cues and the additional aesthetic rule; and
inputting the new editing prompts into the generative AI model and outputting a refined modified image.

5. The method of claim 1, wherein generating the editing prompts comprises generating editing prompts for at least one of: repositioning of the at least one target object within the image; modifying a background of the image; or transforming a perspective of the image for adjusting spatial relationship between the at least one target object and other objects depicted in the image.

6. A system, comprising:
a memory storing instructions;
a processor coupled to the memory and configured by the instructions to at least:
obtain an image;
detect at least one target object depicted in the image;
apply a visual-language model (VLM) to extract the contextual cues from the image relating to the at least one target object;
obtain an aesthetic rule describing a desired post-processing result;
generate editing prompts based on the contextual cues and the aesthetic rule;
perform post-processing on the image by the generative artificial intelligence model based on the editing prompts; and
output a modified image.

7. The system of claim 6, wherein the contextual cues comprise at least one of: positioning of the at least one target object in the image, framing balance, perspective, background complexity, or leading lines.

8. The system of claim 6, wherein the aesthetic rule describing the desired post-processing result comprises one of: user input comprising descriptive text or a pre-defined rule.

9. The system of claim 6, wherein the processor is further configured to:
obtain user input comprising an additional aesthetic rule for refining the modified image;
generate new editing prompts based on the contextual cues and the additional aesthetic rule; and
input the new editing prompts into the generative AI model and outputting a refined modified image.

10. The system of claim 6, wherein the processor is configured to generate the editing prompts by generating editing prompts for at least one of: repositioning of the at least one target object within the image; modifying a background of the image; or transforming a perspective of the image for adjusting spatial relationship between the at least one target object and other objects depicted in the image.

11. A non-transitory computer-readable storage medium storing instructions to be implemented by a computing device having a processor, wherein the instructions, when executed by the processor, cause the computing device to at least:
obtain an image;
detect at least one target object depicted in the image;
apply a visual-language model (VLM) to extract the contextual cues from the image relating to the at least one target object;
obtain an aesthetic rule describing a desired post-processing result;
generate editing prompts based on the contextual cues and the aesthetic rule;
perform post-processing on the image by the generative artificial intelligence model based on the editing prompts; and
output a modified image.

12. The non-transitory computer-readable storage medium of claim 11, wherein the contextual cues comprise at least one of: positioning of the at least one target object in the image, framing balance, perspective, background complexity, or leading lines.

13. The non-transitory computer-readable storage medium of claim 11, wherein the aesthetic rule describing the desired post-processing result comprises one of: user input comprising descriptive text or a pre-defined rule.

14. The non-transitory computer-readable storage medium of claim 11, wherein the processor is further configured by the instructions to:
obtain user input comprising an additional aesthetic rule for refining the modified image;
generate new editing prompts based on the contextual cues and the additional aesthetic rule; and
input the new editing prompts into the generative AI model and outputting a refined modified image.

15. The non-transitory computer-readable storage medium of claim 11, wherein the processor is configured by the instructions to generate the editing prompts by generating editing prompts for at least one of: repositioning of the at least one target object within the image; modifying a background of the image; or transforming a perspective of the image for adjusting spatial relationship between the at least one target object and other objects depicted in the image.
